(19) United States
(12) Patent Application Publication
(10) Pub. No.: US 2002/0015556 A1
(43) Pub. Date: Feb. 7, 2002

(54) Method of fabricating an optical fiber array using photosensitive material

(76) Inventor: Dan A. Steinberg, Blacksburg, VA (US)

Correspondence Address: JONES VOLENTINE, L.L.C., SUITE 150, 12200 SUNRISE VALLEY DRIVE, RESTON, VA, 20191, US

(21) Appl. No.: 09/884,873

(22) Filed: Jun. 19, 2001

Related U.S. Application Data
(60) Provisional application No. 60/212,591, filed on Jun. 19, 2000.

(51) Int. Cl. G02B 6/26

(52) U.S. Cl. 385/31; 385/15

(57) ABSTRACT

A method for fabrication of an optical device includes disposing a photosensitive material over an optical fiber array. A master optical waveguide array is located adjacent the photosensitive material and light is transmitted through the master optical waveguide array. This forms accurately aligned coupling waveguides in the photosensitive material. An optical device includes an optical waveguide array optically coupled to a photosensitive layer having an array of coupling waveguides therein.

### CROSS-REFERENCE TO RELATED APPLICATIONS

The present application claims priority from U.S. Provisional Patent Application Serial No. 60/212,591, filed Jun. 19, 2000 and entitled “Method For Making 2-D Fiber Arrays.” The present application is related to U.S. patent application Ser. No. (Atty. Docket Number ACT.005) entitled “Two-Dimensioanl Fiber Array and Method of Manufacture,” filed on even date herewith. The disclosures of this above captioned provisional patent application and utility patent application are specifically incorporated by reference as though reproduced in their entirety herein.

### FIELD OF THE INVENTION

The present invention relates generally to optical waveguide communications, and particularly to a method of fabricating accurate two-dimensional fiber arrays.

### BACKGROUND OF THE INVENTION

The increasing demand for high-speed voice and data communications has led to an increased reliance on optical communications, particularly optical fiber communications. The use of optical signals as a vehicle to carry channeled information at high speeds is preferred in many instances to carrying channeled information at other electromagnetic wavelengths/frequencies in media such as microwave transmission lines, co-axial cable lines and twisted pair transmission lines. Advantages of optical media are, among others, high-channel capacity (bandwidth), greater immunity to electromagnetic interference, and lower propagation loss. In fact, it is common for high-speed optical communication systems to have signal rates in the range of approximately several Giga bits per second (Gbit/sec) to approximately several tens of Gbit/sec.

One way of carrying information in an optical communication system, for example an optical network, is via an array of optical fibers. Ultimately, the optical fiber array may be coupled to another array of waveguides, such as another optical fiber array, or a waveguide array of an optoelectronic integrated circuit (OEIC). In order to assure the accuracy of the coupling of the fiber array to another waveguide array, it becomes important to accurately position each optical fiber in the array.

One technique to carry out the alignment between a fiber array and another waveguide array is by active alignment followed by bonding. While the accuracy of such a technique may be acceptable, the active alignment techniques are difficult, labor intensive and expensive; and thus are not well suited for large-scale manufacturing.

In view of the drawbacks of active alignment, other techniques for aligning a fiber array for accurate optical coupling have been developed, with mixed results. One such technique is the use of a high-precision metal jig. If fabricated properly, the precision of the metal jig is generally acceptable, and eliminates a great deal of the labor intensity associated with active alignment. However, there can be indexing errors in stepping across the jig during fabrication. This of course can lead to unacceptable inaccuracy. Finally, because the metal jig has a different expansion coefficient than the silica used in optical fibers and other optical waveguides, expansion mismatch can ultimately result in poor alignment.

Silicon waferboard technology has also been used to effect passive alignment in optical fiber communication systems. While silicon waferboard has shown promise in optical fiber array applications, conventional uses of silicon waferboard to passively align an array of optical fibers has also met with mixed results. The drawbacks to conventional silicon waferboard passive alignment of optical fiber arrays include relatively large pitch between fibers, pitch inaccuracy, difficulty inserting optical fibers into eched holes, and often pin-to-pin accuracy problems in certain conventional connector structures.

Accordingly, what is needed is a technique for accurately aligning up optical fibers and accurately maintaining the pitch of the fibers for further coupling to other fibers and/or optical waveguide arrays.

### SUMMARY OF THE INVENTION

The present invention is drawn to a technique for fabricating a two-dimensional optical fiber array.

According to an illustrative embodiment of the present invention, a method of forming an optical device includes disposing a photosensitive material over an optical fiber array. A master optical waveguide array is located adjacent to the photosensitive material, and light is transmitted from the master optical waveguide array into the photosensitive material forming coupling waveguides in the photosensitive material.

According to another illustrative embodiment, an optical device includes an optical waveguide array optically coupled to a photosensitive layer having an array of coupling waveguides therein.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIGS. 1-5 are side views of an optical fiber array undergoing a fabrication sequence according to an exemplary embodiment of the present invention.

FIG. 6 is a side view of an optical fiber array according to an illustrative embodiment of the present invention including a lenslet array disposed over a photosensitive layer.

FIG. 7 is a side view of showing the formation of coupling waveguides in a layer of photosensitive material disposed between an optical fiber array and a master array of multi-mode optical fibers according to an illustrative embodiment of the present invention.

FIG. 8 is a side view of a master optical fiber array in accordance with an exemplary embodiment of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the invention of the present disclosure is drawn to a technique for fabricating a two-dimensional optical fiber array in large scale production having extremely accurate tolerance and pitch, by using a photosensitive material which has accurately formed coupling waveguides therein.

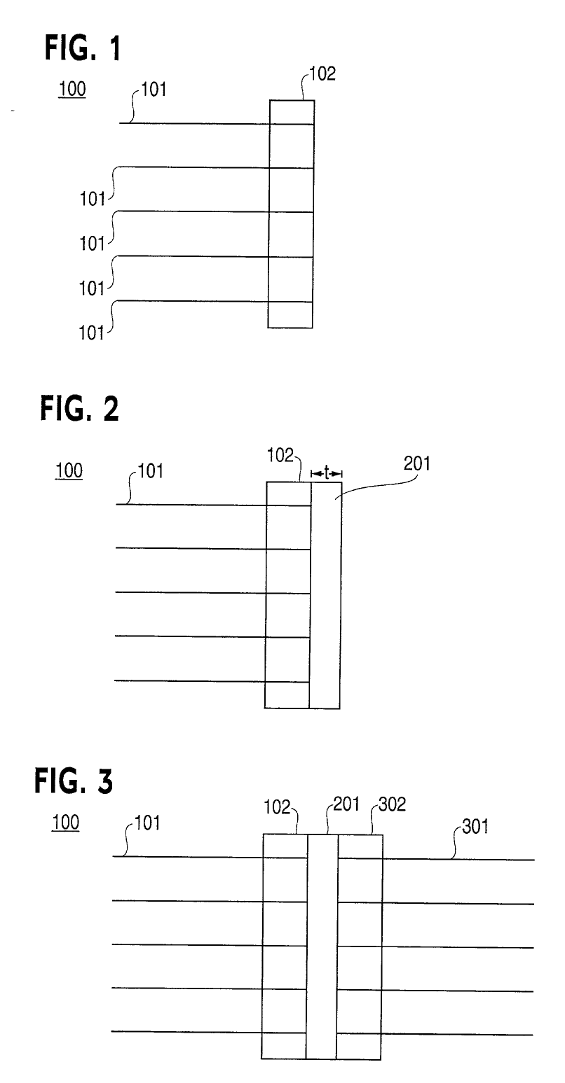

FIG. 1 shows an optical fiber array 100 including optical fibers 101. The optical fibers 101 may be individual fibers, or, more particularly may be rows of fibers extending into the plane of the page. These rows of fibers may in fact be stacks of fiber ribbons or individual optical fibers in rows. Moreover, optical fibers 101 are merely illustrative, and other waveguides may benefit from the exemplary fabrication method of the present invention. These include, but are not limited to integrated waveguides, multifiber ribbons, and polymer waveguides. Finally, the optical fiber array may be a one dimensional (1D) array or a two dimensional (2D) array.

An alignment tool 102 holds the optical fibers 101 into relatively coarse alignment. Illustratively, the alignment tool 102 may be a piece of monocrystalline material, for example monocrystalline silicon, which has v-shaped grooves etched therein. Moreover, the tool 102 may also be a stacked group of sticks forming an array of notches as described in co-pending application “Two-Dimensional Fiber Array and Method of Manufacture”, filed on even date herewith and specifically incorporated by reference herein. The alignment tool 102 may also be a chip with fibers inserted into loose-fitting holes.

FIG. 2 shows a layer of photosensitive material 201 adjacent the optical fibers 101 that are disposed in the alignment tool 102. For purposes of illustration, and not limitation, the photosensitive material 201 may a photopolymer material disposed on the frontface the alignment tool 102. Other photosensitive materials may be used. For example, the photosensitive material may also be a UV curable material (e.g. epoxy, GeO₂ doped SiO₂ or an acrylate/epoxy combination). Further examples of photosensitive materials are disclosed in Self-Organizing Waveguide Coupling Method “SOLNET” and its Application to Film Optical Circuit Substrates, by Yoshimura, et al. (copyright 2000 IEEE. Electronic Components and Technology Conference). The disclosure of the above article is specifically incorporated by reference herein. The thickness of the layer 201 shown as “t” in FIG. 2 is generally a function of the degree of inaccuracy of the optical fiber positions within the alignment tool 102. Accordingly, if the optical fibers 101 are maintained in a relatively inaccurate manner by alignment tool 102, a relatively thick layer of photosensitive material 201 is needed; however, if the optical fibers 101 are maintained in a relatively accurate manner by the alignment tool 102, the thickness “t” of the photosensitive layer 201 may be less thick. Illustratively, the thickness “t” is in the range of approximately 50 μm to approximately 1000 μm.

FIG. 3 shows a master optical waveguide array 302 having optical fibers 301. Illustratively, the master optical waveguide array 302 is approximately a complementary array to optical fibers 101. Moreover, the master optical waveguide array 302 has the desired waveguide location pattern. The master optical waveguide array 302 is in optical communication with the layer of photosensitive material 201. It is noted, that in order to form an accurate waveguide array, the optical fibers 101 held in the alignment tool 102 must be within a certain range of the master optical waveguide array 302. Normally this range is the range of thickness of the photosensitive material 201. As such, the range may depend upon many factors, including the thickness of the photosensitive material 201, the refractive index of the photosensitive material 201, and the mode sizes of the optical modes within the optical fibers. The master optical waveguide array shown in FIG. 3 is illustratively an array of optical fibers. Of course, other optical waveguides may be used instead of the optical fibers. Characteristically, the optical fibers 301 of the master optical waveguide array 302 are more accurately aligned than are the optical fibers 101 disposed in the alignment tool 102. To this end, the master array 302 has optical fibers 301 which are located within a tolerance of approximately ±0.5 μm and have an illustrative pitch in the range on the order of approximately 50 μm to approximately 500 μm.

FIG. 4 shows the fabrication of the coupling waveguides 401. According to an illustrative embodiment of the present invention, light having a wavelength at which the photosensitive material 201 will “cure” is transmitted via the optical fibers 301 of the master array 302. This curing changes the refractive index of the exposed photosensitive material 201. Usefully the index of refraction increases. The light used to form the coupling waveguides 401 is not necessarily the same wavelength as the light to be transmitted in the optical fibers in a deployed optical system (e.g., it may be UV light). Moreover, to ensure better coupling, it may be useful to transmit light through both the optical fibers 101 and the optical fibers 301 thereby curing the photosensitive material 201 from both sides thereof. The coupling waveguides 401 optically couple the optical fibers 301 in the master optical waveguide array 302 with the optical fibers 101. Illustratively, the coupling waveguides 401 are formed one at a time. This serves to ensure that adjacent waveguides are not coupled together.

FIG. 5 shows the removal of the master optical waveguide array 302. The photosensitive layer 201 has coupling waveguides 401 which are accurately located at the front surface 501 of the optical fiber array. By virtue of the illustrative technique of FIGS. 1-5, the resultant optical waveguide array has wavguides located at a predetermined pitch. Moreover, by virtue of the illustrative technique, multiple arrays may be fabricated with substantially identical patterns by using the same master array. It is noted that coupling waveguides substantially correct for inaccuracies in the alignment tool 102.

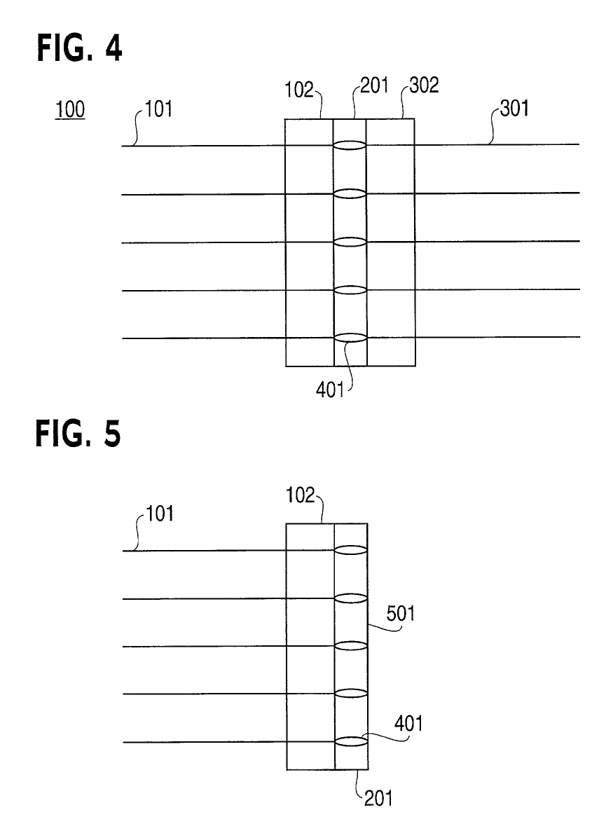

Turning to FIG. 6, another illustrative embodiment of the present invention is disclosed. According to the illustrative embodiment of FIG. 6, the optical fibers 101 of the optical fiber array are disposed in the alignment tool 102, and the coupling waveguides 401 are fabricated in the photosensitive material 201 according to the illustrative techniques described above. An array of lenslets 601 positioned to be in optical communication with the coupling waveguides 401. The resultant array of the illustrative embodiment shown in FIG. 6 is useful in a variety of applications. These include free-space micro-optics such as optical switches.

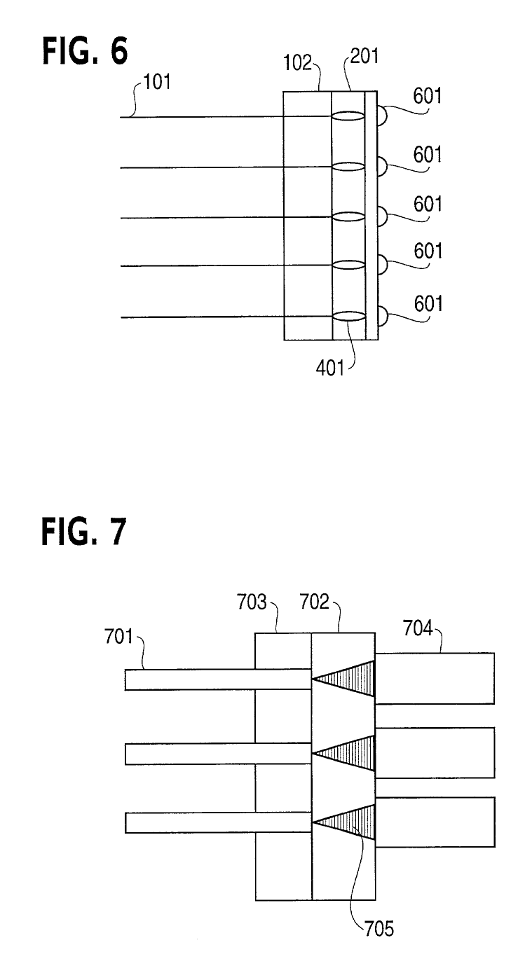

FIG. 7 shows another illustrative embodiment of the invention of the present disclosure is shown. According to the embodiment of FIG. 7, optical fibers 701 are illustratively in an array. To this end, optical fibers 701 may be multiple fibers in an ordered arrangement (e.g. a 1D or 2D array). For example, the optical fibers may be of an optical fiber ribbon or individual optical fibers interleaved in v-groove chips such as the stacked v-groove sticks described in the co-pending application and as referenced above. Photosensitive material 702 is disposed adjacent to the optical fibers which are held in an alignment tool 703. A master array of optical fibers 704 are also adjacent the photosensitive material 702.

The master array of optical fibers 704 is illustratively an array of multi-mode fibers, while the optical fibers 701 are single-mode fibers. Again, the alignment tool 703 is a coarse alignment tool, whereas the master array is aligned having a very accurate pitch. The multi-mode nature of the master array of optical fibers 704 provides funnel-shaped coupling waveguides 705. Ultimately, this embodiment may be beneficial, as it fosters relatively easy coupling of light into the single mode fiber array.

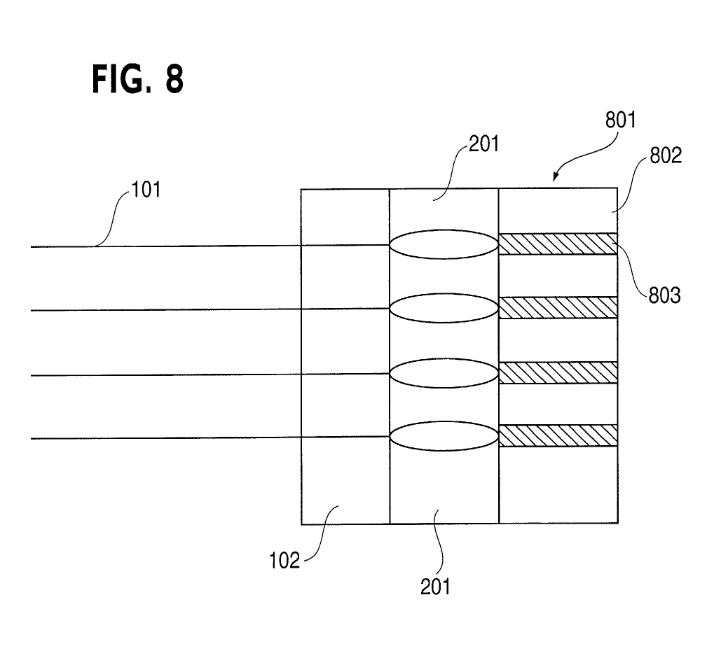

FIG. 8 shows another illustrative embodiment of the present invention wherein an array chip 801 is disposed adjacent to the photosensitive layer 201. The array chip 801 is illustratively a micromachined chip (e.g., RIE-etched silicon). The array chip 801 comprises a substrate 802 with optical fibers stubs 803 disposed therein. The optical fiber stubs 803 may be single mode or multimode optical fiber stubs. Illustratively, the array chip 801 is polished on both sides. The array chip 801 may be used as the master array in the illustrative embodiments formerly described. However, unlike the formerly described illustrative embodiments, the array chip 801 may be a permanent element of the resultant device.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

We claim:

1. A method of forming an optical device, the method comprising:
a) disposing a photosensitive material adjacent an optical waveguide array;
b) locating a master optical waveguide array adjacent said photosensitive material;
c) transmitting light from the master optical waveguide array into said photosensitive material forming coupling waveguides therein.

2. A method as recited in claim 1, wherein the method further comprises transmitting light from the optical waveguide array into said photosensitive material.

3. A method as recited in claim 1, wherein said optical waveguide array further comprises at least one optical fiber disposed in an alignment tool.

4. A method as recited in claim 3, wherein the alignment tool is adjacent said photosensitive material.

5. A method as recited in claim 1, wherein said photosensitive material is a photopolymer.

6. A method as recited in claim 1, the method further comprising:
d) removing said master optical waveguide array after (c).

7. A method as in claim 6, further comprising disposing a lenslet array adjacent said photosensitive material after (d), said lenslet array being optically coupled to said coupling waveguides.

8. A method as recited in claim 3, wherein said alignment tool is formed of a monocrystalline material.

9. A method as recited in claim 3, wherein said alignment tool further comprises a plurality of sticks having notches therein, wherein said sticks are stacked to form an array of said notches.

10. A method as recited in claim 1, wherein said photosensitive material has a surface, and said coupling waveguides are substantially coplanar in a plane of said surface.

11. A method as recited in claim 1, wherein said optical waveguide array further comprises a plurality of waveguides chosen from the group consisting essentially of integrated waveguides, multi-fiber ribbons and polymer waveguides.

12. A method as recited in claim 1, wherein said master fiber array further comprises a substrate having openings therein, and an optical fiber stub disposed in each of said openings.

13. A method as recited in claim 12, wherein said master fiber array is not removed after said forming of coupling waveguides in said photosensitive material.

14. A method as recited in claim 5, wherein said photopolymer has a thickness in the range of approximately 50 μm to approximately 100 μm.

15. A method as recited in claim 1, wherein said master optical waveguide array includes a plurality multi-mode optical waveguides.

16. A method as recited in claim 1, wherein said optical waveguides further includes a plurality of single-mode waveguides.

17. A method as recited in claim 1, wherein said coupling waveguides are formed one at a time.

18. A method as recited in claim 1, wherein adjacent coupling waveguides are not formed simultaneously.

19. An optical device, comprising:
An optical waveguide array optically coupled to a photosensitive layer having an array of coupling waveguides therein.

20. An optical device as recited in claim 19, wherein said optical waveguide array further includes a plurality of waveguides chosen from the group consisting essentially of integrated waveguides, multi-fiber ribbons and polymer waveguides.

21. An optical device as recited in claim 19, wherein said optical waveguide array further includes an array of single-mode waveguides.

22. An optical device as recited in claim 19, wherein said photosensitive material is a photopolymer.

23. An optical device as recited in claim 19, further comprising a lenslet array optically coupled to said coupling waveguides.

24. An optical device as recited in claim 19, wherein said coupling waveguides are coupled to an optical switching device.

25. An optical device, comprising:
An optical waveguide array;
a master array; and
a photosensitive layer having an array of coupling waveguides therein, said photosensitive layer being disposed between said master array and said optical waveguide array.

26. An optical device as recited in claim 25, wherein said master optical waveguide array further comprises a substrate having openings therein, and an optical fiber stub disposed in each of said openings.
